(19) United States
(12) Patent Application Publication
(10) Pub. No.: US 2025/0293272 A1
(43) Pub. Date: Sep. 18, 2025

(54) METAL BEAD SEAL BUCKLING LOAD AND PRESSURE UNIFORMITY WITH AN ENFORCEMENT LAYER

(71) Applicant: GM Global Technology Operations LLC, Detroit, MI (US)

(72) Inventors: Siguang Xu, Rochester Hills, MI (US); Liang Xi, Northville, MI (US); Glenn W. Skala, Churchville, NY (US)

(73) Assignee: GM Global Technology Operations LLC, Detroit, MI (US)

(21) Appl. No.: 18/603,718

(22) Filed: Mar. 13, 2024

(51) Int. Cl. H01M 8/0247; B60L 50/72; H01M 8/0276; H01M 8/1004; H01M 8/241

(52) U.S. Cl. CPC H01M 8/0247; B60L 50/72; H01M 8/0276; H01M 8/1004; H01M 8/241; H01M 2250/20

(57) ABSTRACT

A bipolar plate includes an anode plate and a cathode plate. The anode plate has an interior side and an exterior side opposite the interior side. The cathode plate has an interior side and an exterior side opposite the interior side. The interior side of the cathode plate faces the interior side of the anode plate. The bipolar plate includes a bead region. A portion of the interior side of the anode plate at the bead region is spaced from a portion of the interior side of the cathode plate at the bead region. An enforcement layer is disposed between the interior side of the anode plate and the interior side of the cathode plate at the bead region. The enforcement layer is configured to resist compression forces experienced at the exterior side of the anode plate and the exterior side of the cathode plate at the bead region.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to fuel cell systems for vehicles, and more particularly, to bipolar plates separating neighboring fuel cells of the fuel cell system. Specifically, the present disclosure provides a bipolar plate for a vehicular fuel cell system having an anode plate and a cathode plate, where an enforcement layer or structure is disposed between the anode plate and the cathode plate at least at a bead region of the bipolar plate.

Fuel cell systems for powering propulsion systems of vehicles, such as passenger vehicles and commercial vehicles, commonly include a fuel cell stack having a plurality of fuel cells connected in series by stacking the fuel cells on top of each other. Typically, each cell includes a membrane electrode assembly sandwiched between a pair of bipolar plates. The bipolar plates of adjacent cells engage one another to provide electrically conductive connection between the cells, add physical strength to the fuel cell stack, and may seal a flow field extending across the bipolar plate and/or the membrane electrode assembly. Forces experienced by the bipolar plates, such as to create the seal between adjacent bipolar plates or excessive forces experienced during a vehicle collision or due to vibration or stress during operation of the vehicle, can cause excessive compression or buckling of the bipolar plates and lead to loss of electrical connection between cells and leakage from the flow field.

To improve the structural integrity and sealing of the fuel cell stack, a bipolar plate including an anode plate and a cathode plate has an enforcement layer between the anode plate and the cathode plate at least at a bead region of the bipolar plate. The bead region of the bipolar plate includes a chamber between respective interior sides of the anode plate and the cathode plate and respective gaskets at the exterior sides of the anode plate and the cathode plate. When the bipolar plate is disposed within the fuel cell stack of a fuel cell system, the gaskets engage respective structures of the fuel cell stack. The enforcement layer is coupled to the interior sides of the anode plate and the cathode plate and extends within the chamber to reduce the effect of compressive forces on the structural integrity of the bead region of the bipolar plate.

### SUMMARY

One aspect of the disclosure provides a bipolar plate. The bipolar plate includes an anode plate and a cathode plate. The anode plate has an interior side and an exterior side opposite the interior side. The cathode plate has an interior side and an exterior side opposite the interior side. The interior side of the cathode plate faces the interior side of the anode plate. The bipolar plate includes a bead region. A portion of the interior side of the anode plate at the bead region is spaced from a portion of the interior side of the cathode plate at the bead region. The bipolar plate includes an enforcement layer disposed between the interior side of the anode plate and the interior side of the cathode plate at the bead region. The enforcement layer is configured to resist compression forces experienced at the exterior side of the anode plate and the exterior side of the cathode plate at the bead region.

Implementations of the disclosure may include one or more of the following optional features. In some implementations, the bipolar plate further includes a first gasket and a second gasket. The first gasket is disposed at the exterior side of the anode plate at the bead region. The second gasket is disposed at the exterior side of the cathode plate at the bead region. The first gasket and the second gasket are configured to engage respective membrane electrode assemblies of a fuel cell stack of a fuel cell system when the bipolar plate is disposed in the fuel cell stack. In further implementations, the first gasket and the second gasket are configured to seal respective flow fields that extend across the exterior sides of the anode plate and the cathode plate when engaging the respective membrane electrode assemblies of the fuel cell stack.

In some examples, the bipolar plate further includes a chamber defined between the portion of the interior side of the anode plate at the bead region and the portion of the interior side of the cathode plate at the bead region. The enforcement layer extends within the chamber at the bead region. In further examples, the enforcement layer includes an aperture that fluidly connects a first portion of the chamber between the interior side of the anode plate and the enforcement layer and a second portion of the chamber between the interior side of the cathode plate and the enforcement layer.

In some aspects, the enforcement layer includes a spline disposed between the portion of the interior side of the anode plate and the portion of the interior side of the cathode plate at the bead region and not disposed between other portions of the interior side of the anode plate and other portions of the interior side of the cathode plate remote from the bead region.

In some implementations, the enforcement layer includes an intermediate plate disposed between the portion of the interior side of the anode plate and the portion of the interior side of the cathode plate at the bead region and disposed between other portions of the interior side of the anode plate and other portions of the interior side of the cathode plate remote from the bead region.

In some examples, one of the anode plate and the cathode plate includes a carrier portion that is recessed from the interior side of the respective one of the anode plate and the cathode plate. The enforcement layer is accommodated within the carrier portion.

In some aspects, the enforcement layer is non-planar. In some implementations, the enforcement layer is laser welded to the anode plate and the cathode plate.

Another aspect of the disclosure provides a fuel cell system. The fuel cell system includes a fuel cell stack. The fuel cell stack includes a plurality of fuel cells. At least one fuel cell of the plurality of fuel cells includes a membrane electrode assembly sandwiched between a pair of bipolar plates. Each bipolar plate of the pair of bipolar plates includes an anode plate and a cathode plate. The anode plate has an interior side and an exterior side opposite the interior side. The cathode plate has an interior side and an exterior side opposite the interior side. The interior side of the cathode plate faces the interior side of the anode plate. Each bipolar plate includes a bead region. A portion of the interior side of the anode plate at the bead region is spaced from a portion of the interior side of the cathode plate at the bead region. Each bipolar plate includes an enforcement layer disposed between the interior side of the anode plate and the interior side of the cathode plate at the bead region. The enforcement layer is configured to resist compression forces experienced at the exterior side of the anode plate and the exterior side of the cathode plate at the bead region. This aspect may include one or more of the following optional features.

In some implementations, each bipolar plate of the pair of bipolar plates further includes a first gasket and a second gasket. The first gasket is disposed at the exterior side of the anode plate at the bead region. The second gasket is disposed at the exterior side of the cathode plate at the bead region. The first gasket and the second gasket engage respective membrane electrode assemblies of the fuel cell stack.

In some examples, the fuel cell system further includes a chamber defined between the portion of the interior side of the anode plate at the bead region and the portion of the interior side of the cathode plate at the bead region. The enforcement layer extends within the chamber at the bead region.

In some aspects, the enforcement layer includes a spline disposed between the portion of the interior side of the anode plate and the portion of the interior side of the cathode plate at the bead region and not disposed between other portions of the interior side of the anode plate and other portions of the interior side of the cathode plate remote from the bead region.

In some implementations, the enforcement layer includes an intermediate plate disposed between the portion of the interior side of the anode plate and the portion of the interior side of the cathode plate at the bead region and disposed between other portions of the interior side of the anode plate and other portions of the interior side of the cathode plate remote from the bead region.

Yet another aspect of the disclosure provides a vehicle. The vehicle includes a fuel cell system having a fuel cell stack. The fuel cell stack includes a plurality of fuel cells. At least one fuel cell of the plurality of fuel cells includes a membrane electrode assembly sandwiched between a pair of bipolar plates. Each bipolar plate of the pair of bipolar plates includes an anode plate and a cathode plate. The anode plate has an interior side and an exterior side opposite the interior side. The cathode plate has an interior side and an exterior side opposite the interior side. The interior side of the cathode plate faces the interior side of the anode plate. Each bipolar plate includes a bead region. A portion of the interior side of the anode plate at the bead region is spaced from a portion of the interior side of the cathode plate at the bead region. Each bipolar plate includes an enforcement layer disposed between the interior side of the anode plate and the interior side of the cathode plate at the bead region. The enforcement layer is configured to resist compression forces experienced at the exterior side of the anode plate and the exterior side of the cathode plate at the bead region. This aspect may include one or more of the following optional features.

In some implementations, each bipolar plate of the pair of bipolar plates further includes a first gasket and a second gasket. The first gasket is disposed at the exterior side of the anode plate at the bead region. The second gasket is disposed at the exterior side of the cathode plate at the bead region. The first gasket and the second gasket engage respective membrane electrode assemblies of the fuel cell stack.

In some examples, the vehicle further includes a chamber defined between the portion of the interior side of the anode plate at the bead region and the portion of the interior side of the cathode plate at the bead region. The enforcement layer extends within the chamber at the bead region.

In some aspects, the enforcement layer includes a spline disposed between the portion of the interior side of the anode plate and the portion of the interior side of the cathode plate at the bead region and not disposed between other portions of the interior side of the anode plate and other portions of the interior side of the cathode plate remote from the bead region.

In some implementations, the enforcement layer includes an intermediate plate disposed between the portion of the interior side of the anode plate and the portion of the interior side of the cathode plate at the bead region and disposed between other portions of the interior side of the anode plate and other portions of the interior side of the cathode plate remote from the bead region.

The details of one or more implementations of the disclosure are set forth in the accompanying drawings and the description below. Other aspects, features, and advantages will be apparent from the description, and from the claims.

### BRIEF DESCRIPTION OF THE DRAWINGS

The drawings described herein are for illustrative purposes only of selected configurations and are not intended to limit the scope of the present disclosure.

FIG. 1 is an exploded view of a fuel cell stack of a fuel cell system.

FIG. 2 is a plan view of a bipolar plate of the fuel cell system.

FIG. 3 is a plan view of an enforcement layer of the bipolar plate.

FIGS. 4A-4E are cross-sectional views of example configurations of a bead region of the bipolar plate, taken along line 4-4 of FIG. 2.

FIG. 5A is an enlarged view of the bead region of the bipolar plate at area 5A of FIG. 2.

FIGS. 5B-5D are cross-sectional views of example configurations of bead regions of bipolar plates and corresponding pressure gradients along a curved portion of the respective bead region under compression.

FIG. 5E is a graph showing displacement of the bead regions of FIGS. 5B-5D under compression loads.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit,” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

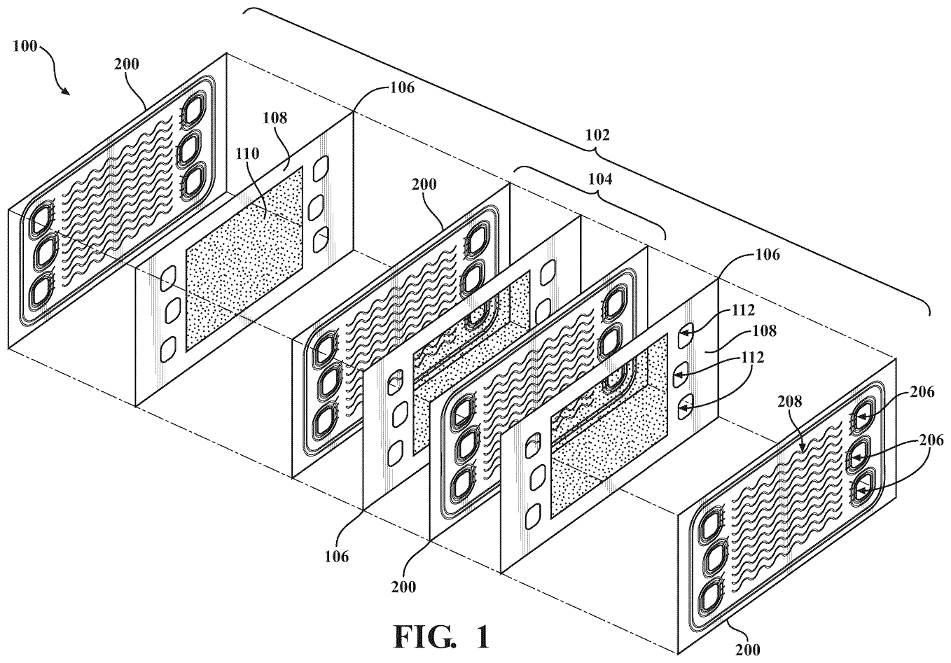

Referring now to the figures and the illustrated configurations depicted therein, a fuel cell system 100 for powering a propulsion system of a vehicle (e.g., a passenger vehicle, mass transit vehicle, commercial vehicle, and the like) includes a fuel cell stack 102 having a plurality of power generation cells or fuel cells 104 (FIG. 1). Each fuel cell 104 may include a membrane electrode assembly (MEA) 106 or a unitized electrode assembly (UEA) sandwiched between a pair of bipolar plates (BPPs) 200. For example, the MEA 106 may include a membrane 108 accommodating a catalyst 110 (e.g., including an anode layer and a cathode layer on opposite sides of the membrane 108). The BPPs 200 provide structural support to the fuel cell stack 102 and electrically connect the fuel cells 104 in series so that electricity generated at the MEAs 106 of the fuel cell stack 102 produce a usable output voltage.

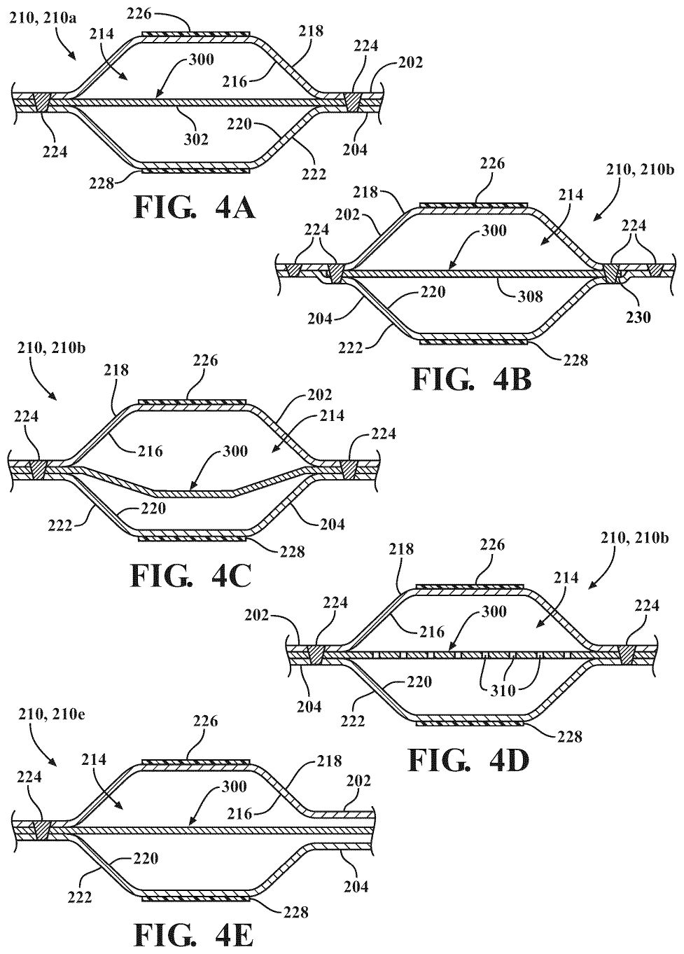

Each BPP 200 includes an anode plate or panel 202 and a cathode plate or panel 204 (FIGS. 4A-4E). The anode plate 202 and the cathode plate 204 may be formed from a metallic material, carbon, or a composite material. For example, the anode plate 202 and the cathode plate 204 may be formed from plates of steel, stainless steel (e.g., 304 stainless steel, 316 stainless steel, or ferritic stainless steel), plated steel, aluminum, titanium, or surface-treated metal having a thickness of 85 microns or less. The anode plate 202 and the cathode plate 204 are stamped to form and joined together, such as by welding (e.g., laser welding), brazing, or crimping at the outer peripheries of the plates. When disposed within the fuel cell stack 102, the anode plates 202 and cathode plates 204 may be arranged in an alternating pattern so that an anode plate 202 engages one side of an MEA 106 and a cathode plate 204 engages the opposite side of the MEA 106 to channel electricity in a given direction through the fuel cell stack 102.

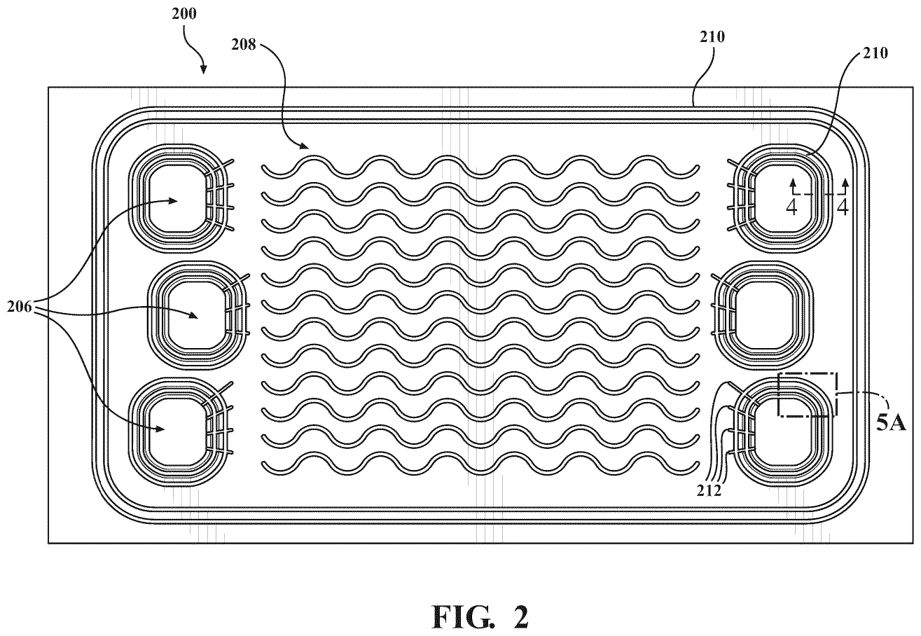

As shown in FIGS. 1 and 2, respective openings or channels 206 are formed through the BPPs 200 and align with respective openings or channels 112 formed through the MEAs 106 to define passageways along the fuel cell stack 102 that allow fluid communication between fuel cells 104. For example, respective passageways extending between the BPPs 200 and MEAs 106 of the fuel cell stack 102 may carry oxygen containing gas, hydrogen fuel gas, and coolant to flow between the fuel cells 104 of the fuel cell stack 102. Each BPP 200 defines a flow field 208 across an outer face of the BPP 200 to allow for flow of fluid between the BPP 200 and the MEA 106, where the flow field 208 may include a series of channels or valleys and protrusions that guide flow across the BPP 200 and between two or more openings 206 (i.e., an inlet opening and an outlet opening). For example, the fuel cell system 100 may include characteristics of the fuel cell systems and fuel cells described in U.S. Pat. Nos. 10,211,473; 10,411,272; 10,522,847; and/or 10,529,996, which are hereby incorporated herein by reference in their entireties.

As described further below, the BPP 200 includes one or more beads or bead regions 210, 210a-e raised relative to the flow field 208 and that engage respective structures within the fuel cell stack 102 to separate a portion of the BPP 200 from the MEA 106 to allow for fluid communication therebetween and to seal portions of the flow field 208 and contain fluid flow along desired paths. For example, the bead 210 may be formed about an outer peripheral region of the BPP 200 and configured to engage a side of the MEA 106 and/or another BPP 200 to seal the outer edge of the flow field 208. Further, the bead 210 may be at least partially formed about an opening 206 and configured to engage a side of the MEA 106 to fluidly isolate or allow fluid communication between the opening 206 and the flow field 208. That is, the bead 210 may circumscribe the opening 206 to fluidly isolate the opening 206 and the flow field 208 or the bead 210 may partially circumscribe the opening 206 to allow fluid flow between the opening 206 and the flow field 208, such that the fluid flowing through the opening 206 may only be delivered to designated portions of the fuel cell stack 102. For example, one or more channels or tubes 212 may extend between an opening 206 and the flow field 208 through the bead region 210 to fluidly couple that opening 206 and the flow field 208. Thus, the beads 210 space the BPP 200 from the MEA 106 to allow at least one of the oxygen gas, hydrogen gas, and coolant to flow across the flow field surface 208 of the BPP 200 between inlet and outlet openings 206. Structural integrity of the beads 210 is critical to prevent leakage and maintain electrical connection across fuel cells 104.

As shown in FIGS. 4A-4E, each bead 210 is formed from a projection of the anode plate 202 or cathode plate 204 engaging an adjacent structure (e.g., the MEA 106 or another BPP 200) of the fuel cell stack 102. In the illustrated example, the anode plate 202 and the cathode plate 204 both include respective projections, such as to provide uniform spacing between BPPs 200 and MEAs 106 and more direct paths for compression forces at the fuel cell stack 102. Because the anode plate 202 and the cathode plate 204 are formed from metallic plates having a uniform thickness, the respective projections are stamped into the plates and result in a chamber or cavity 214 being formed between the anode plate 202 and the cathode plate 204. The chamber 214 may facilitate fluid flow between the opening 206 and the flow field 208.

Accordingly, the anode plate 202 has an interior side 216 and an exterior side 218 opposite the interior side 216 and the cathode plate 204 has an interior side 220 and an exterior side 222 opposite the interior side 220. The interior side 216 of the anode plate 202 faces the interior side 220 of the cathode plate 204. with the interior side 216 of the anode plate 202 spaced from the interior side 220 of the cathode plate 204 at the bead region 210 of the BPP 200 to define the chamber 214 and raise the bead 210 relative to the flow field 208. Portions of the anode plate 202 may be coupled to portions of the cathode plate 204 remote from the bead region 210, such as via laser weld joints 224, to join the anode plate 202 and the cathode plate 204 and fluidly seal the chamber 214.

A first gasket 226 is disposed at the exterior side 218 of the anode plate 202 at the bead region 210 and a second gasket 228 is disposed at the exterior side 222 of the cathode plate 204 at the bead region 210 so that, with the BPP 200 disposed within the fuel cell stack 102, the first gasket 226 and the second gasket 228 engage respective structures of the fuel cell stack 102 and seal the respective flow fields 208 extending across the exterior side 218 of the anode plate 202 and the exterior side 222 of the cathode plate 204. For example, the gaskets may engage one or more of an MEA 106, another BPP 200, an end plate of the fuel cell stack 102, and the like. The first gasket 226 and the second gasket 228 may be formed from a rubberized polymer or any suitable material configured to compress and/or flex to seal between adjacent surfaces.

To reduce compression of the bead region 210 and lateral movement of the anode plate 202 and cathode plate 204 relative to one another when a compression force is experienced at the BPP 200, an enforcement layer 300 is disposed between the interior side 216 of the anode plate 202 and the interior side 220 of the cathode plate 204 at least at the bead region 210. For example, when the fuel cell stack 102 is assembled, a compression force may be applied along the fuel cell stack 102 to maintain electrical connection between fuel cells 104 and enable sealing along a seal path defined by the gaskets at the bead regions 210. Additional forces may act on the bead region 210 during operation of the vehicle and/or in the event of a vehicle collision. Excessive compression or buckling of the bead region 210 can result in leakage from the flow field 208 and/or electrical disconnect between fuel cells 104. The enforcement layer 300 strengthens the bead region 210 against buckling loads and provides uniform pressure distribution across the seal of the bead region 210, thus reducing or eliminating buckling of the plates.

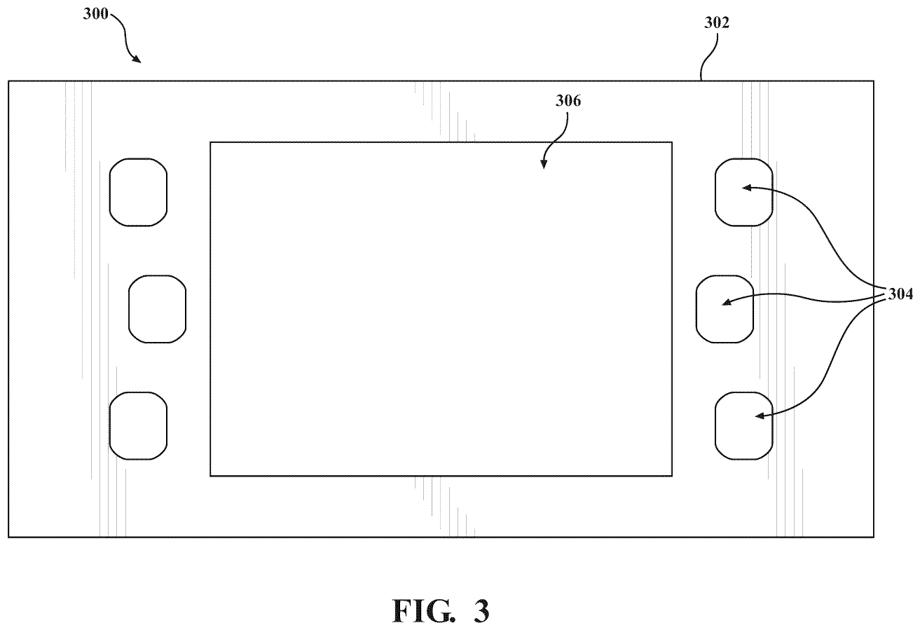

As shown in FIG. 3, the enforcement layer 300 may include a stamped plate or panel 302 disposed between the anode plate 202 and the cathode plate 204. The enforcement layer 300 may be formed from the same material as the anode plate 202 and the cathode plate 204, or the enforcement layer 300 may be formed from a different material, such as a thinner metal (e.g., having a thickness of 75 microns or less or 65 microns or less) and/or a softer metal (e.g., titanium, aluminum, stainless steel, and the like). In the illustrated example, the enforcement plate 302 includes respective openings 304 configured to align with the openings 112 of the MEAs 106 and the openings 206 of the BPPs 200, and a void or aperture 306 configured to align with the flow field 208. Thus, the enforcement plate 302 is disposed between the interior side 216 of the anode plate 202 and the interior side 220 of the cathode plate 204 at the bead region 210 and at other portions of the BPP 200 remote from the bead region 210.

Referring to FIG. 4A, a first example of the bead region 210, 210a includes the enforcement plate 302 extending across and/or within the chamber 214 between the anode plate 202 and the cathode plate 204. Respective laser weld joints 224 may be formed along opposing sides of the chamber 214 to join the anode plate 202, the cathode plate 204, and the enforcement layer 300 together. In the illustrated example, the bead region 210a is symmetric such that the enforcement plate 302 is substantially planar and the interior side 216 of the anode plate 202 and the interior side 220 of the cathode plate 204 are equally spaced from the enforcement layer 300.

As shown in FIG. 4B, a second example of the bead region 210, 210b has an enforcement layer 300 provided as an enforcement spline or insert 308. The spline 308 is disposed between the anode plate 202 and the cathode plate 204 only at or near the bead region 210b, such as to reduce thickness of the BPP 200 remote from the bead region 210. In other words, the spline 308 is disposed between the interior side 216 of the anode plate 202 and the interior side 220 of the cathode plate 204 at the bead region 210b and the spline 308 is not disposed between the interior side 216 of the anode plate 202 and the interior side 220 of the cathode plate 204 remote from the bead region 210b. The cathode plate 204 includes a recessed portion or carrier portion 230 recessed from the interior side 220 of the cathode plate 204 to accommodate the peripheral edge portions of the spline 308, such that the planar spline 308 may extend substantially parallel to a plane of the cathode plate 204. In some examples, the anode plate 202 may alternatively or additionally include recessed portions for at least partially accommodating the edge portions of the spline 308. Laser weld joints 224 may directly couple the anode plate 202 and the cathode plate 204 remote from the bead region 210b, while laser weld joints 224 couple the anode plate 202, the cathode plate 204, and the spline 308 within the bead region 210b.

In a third example of the bead region 210, 210c, and such as shown in FIG. 4C, at least a portion of the enforcement layer 300 is non-planar. In other words, the enforcement layer 300 may be bent, curved, or biased toward one of the anode plate 202 and the cathode plate 204 to provide an asymmetrical bead region 210c. The asymmetrical or biased enforcement layer 300 may provide tailored pressure distribution and stiffness across the bead 210c.

Referring to FIG. 4D, a fourth example of the bead region 210, 210d has one or more perforations or vents 310 formed through the enforcement layer 300. The perforations 310 relax the stiffness of the bead region 210d and allow for fluid communication between the portion of the chamber 214 between the anode plate 202 and the enforcement layer 300 and the portion of the chamber 214 between the cathode plate 204 and the enforcement layer 300.

As shown in FIG. 4E, a fifth example of the bead region 210, 210e shows the enforcement layer 300 coupled to the anode plate 202 and the cathode plate 204 via a laser welding joint 224 at one end and extending along a channel 212 of the BPP 200 at the other end. That is, portions of the enforcement layer 300 may be spaced from the interior side 216 of the anode plate 202 and/or the interior side 220 of the cathode plate 204, such as along the channels 212, to allow for fluid communication from the chamber 214 and between the enforcement layer 300 and the anode plate 202 and/or cathode plate 204.

The bead 210 may be adjusted or tuned (such as by adjusting the geometry and shape of the enforcement layer 300) to achieve desired sealing pressure and bead stiffness at different regions of the BPP 200. For example, portions of the bead 210 may be symmetric (e.g., FIG. 4A) to provide a uniform sealing pressure at the first gasket 226 and the second gasket 228 and to provide high buckling load resisting compression forces at the bead 210. Further, the enforcement layer 300 may be curved (e.g., FIG. 4C) and/or include perforations 310 (e.g., FIG. 4D) to relax the bead stiffness, such as at corner regions of the bead 210. The enforcement layer 300 may be disposed between the anode plate 202 and the cathode plate 204 across the entire bead seal path (e.g., an enforcement plate 302) or the enforcement layer 300 may be selectably placed across only a portion of the bead seal path (e.g., an enforcement spline 308).

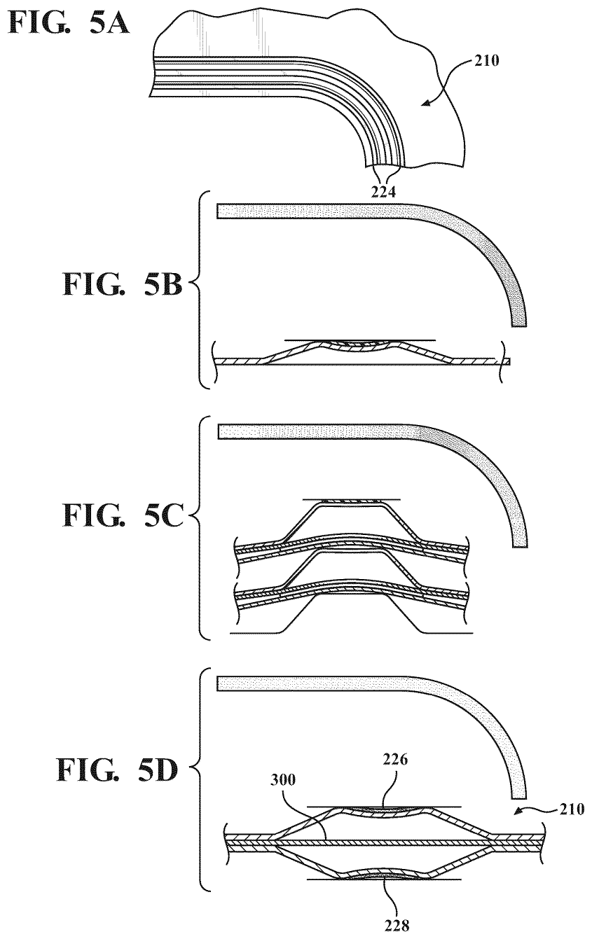

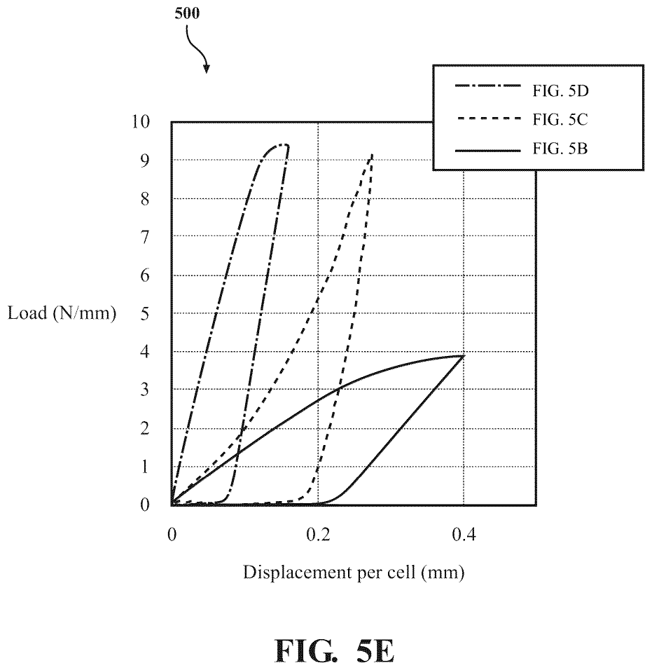

With reference to FIGS. 5A-5E, a chart 500 depicts example displacements under compression load for BPPs having differently configured bead regions. That is, the chart 500 graphs example compression of a bead without the enforcement layer (FIG. 5B), a single-sided bead when disposed within the fuel cell stack (FIG. 5C), and the bead region 210 having the enforcement layer 300 (FIG. 5D). As shown, the bead region 210 having the enforcement layer 300 provides superior structural integrity for the fuel cell stack, resisting displacement or compression even at higher compression loads.

Further, compression charts 502, 502b-d of FIGS. 5B-5D are representative of pressure experienced along the curved portion of the bead shown in FIG. 5A. As shown, the bead region 210 having the enforcement layer provides uniform pressure distribution at the first gasket 226 and the second gasket 228 along the straight and curved portions of the bead seal.

Thus, the BPP 200 of the fuel cell system 100 includes an enforcement layer 300 disposed between the anode plate 202 and the cathode plate 204 of the BPP 200 at least at a bead region 210 of the BPP 200. The enforcement layer 300 results in a high resistance to buckling loads at the BPP 200 to reduce compression or buckling of the bead region 210 and provide more uniform sealing between the BPP 200 and adjacent structures within the fuel cell stack 102, such as a neighboring BPP 200 and/or the MEA 106. The enforcement layer 300 may be tuned to adjust stiffness at different portions of the bead region 210 and to allow or prevent fluid communication between different portions of the inner chamber 214 of the bead 210. Further, inclusion of the enforcement layer 300 allows for the anode plate 202 and the cathode plate 204 to be made from thinner and/or softer metallic plates, resulting in weight reduction of the fuel cell stack 102 without sacrificing structural integrity.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A bipolar plate comprising:
an anode plate having an interior side and an exterior side opposite the interior side;
a cathode plate having an interior side and an exterior side opposite the interior side, the interior side of the cathode plate facing the interior side of the anode plate;
a bead region, a portion of the interior side of the anode plate at the bead region spaced from a portion of the interior side of the cathode plate at the bead region; and
an enforcement layer disposed between the interior side of the anode plate and the interior side of the cathode plate at the bead region, the enforcement layer configured to resist compression forces experienced at the exterior side of the anode plate and the exterior side of the cathode plate at the bead region.

2. The bipolar plate of claim 1, further comprising:
a first gasket disposed at the exterior side of the anode plate at the bead region; and
a second gasket disposed at the exterior side of the cathode plate at the bead region, the first gasket and the second gasket configured to engage respective membrane electrode assemblies of a fuel cell stack of a fuel cell system when the bipolar plate is disposed in the fuel cell stack.

3. The bipolar plate of claim 2, wherein the first gasket and the second gasket are configured to seal respective flow fields that extend across the exterior sides of the anode plate and the cathode plate when engaging the respective membrane electrode assemblies of the fuel cell stack.

4. The bipolar plate of claim 1, further comprising a chamber defined between the portion of the interior side of the anode plate at the bead region and the portion of the interior side of the cathode plate at the bead region, the enforcement layer extending within the chamber at the bead region.

5. The bipolar plate of claim 4, wherein the enforcement layer comprises an aperture that fluidly connects a first portion of the chamber between the interior side of the anode plate and the enforcement layer and a second portion of the chamber between the interior side of the cathode plate and the enforcement layer.

6. The bipolar plate of claim 1, wherein the enforcement layer comprises a spline disposed between the portion of the interior side of the anode plate and the portion of the interior side of the cathode plate at the bead region and not disposed between other portions of the interior side of the anode plate and other portions of the interior side of the cathode plate remote from the bead region.

7. The bipolar plate of claim 1, wherein the enforcement layer comprises an intermediate plate disposed between the portion of the interior side of the anode plate and the portion of the interior side of the cathode plate at the bead region and disposed between other portions of the interior side of the anode plate and other portions of the interior side of the cathode plate remote from the bead region.

8. The bipolar plate of claim 1, wherein one of the anode plate and the cathode plate comprises a carrier portion that is recessed from the interior side of the respective one of the anode plate and the cathode plate, the enforcement layer accommodated within the carrier portion.

9. The bipolar plate of claim 1, wherein the enforcement layer is non-planar.

10. The bipolar plate of claim 1, wherein the enforcement layer is laser welded to the anode plate and the cathode plate.

11. A fuel cell system comprising:
a fuel cell stack, the fuel cell stack comprising a plurality of fuel cells, at least one fuel cell of the plurality of fuel cells comprising a membrane electrode assembly sandwiched between a pair of bipolar plates, each bipolar plate of the pair of bipolar plates comprising:
an anode plate having an interior side and an exterior side opposite the interior side;
a cathode plate having an interior side and an exterior side opposite the interior side, the interior side of the cathode plate facing the interior side of the anode plate;
a bead region, a portion of the interior side of the anode plate at the bead region spaced from a portion of the interior side of the cathode plate at the bead region; and
an enforcement layer disposed between the interior side of the anode plate and the interior side of the cathode plate at the bead region, the enforcement layer configured to resist compression forces experienced at the exterior side of the anode plate and the exterior side of the cathode plate at the bead region.

12. The fuel cell system of claim 11, wherein each bipolar plate of the pair of bipolar plates further comprises:
a first gasket disposed at the exterior side of the anode plate at the bead region; and
a second gasket disposed at the exterior side of the cathode plate at the bead region, the first gasket and the second gasket engaging respective membrane electrode assemblies of the fuel cell stack.

13. The fuel cell system of claim 11, further comprising a chamber defined between the portion of the interior side of the anode plate at the bead region and the portion of the interior side of the cathode plate at the bead region, the enforcement layer extending within the chamber at the bead region.

14. The fuel cell system of claim 11, wherein the enforcement layer comprises a spline disposed between the portion of the interior side of the anode plate and the portion of the interior side of the cathode plate at the bead region and not disposed between other portions of the interior side of the anode plate and other portions of the interior side of the cathode plate remote from the bead region.

15. The fuel cell system of claim 11, wherein the enforcement layer comprises an intermediate plate disposed between the portion of the interior side of the anode plate and the portion of the interior side of the cathode plate at the bead region and disposed between other portions of the interior side of the anode plate and other portions of the interior side of the cathode plate remote from the bead region.

16. A vehicle comprising:
a fuel cell system having a fuel cell stack, the fuel cell stack comprising a plurality of fuel cells, at least one fuel cell of the plurality of fuel cells comprising a membrane electrode assembly sandwiched between a pair of bipolar plates, each bipolar plate of the pair of bipolar plates comprising:
an anode plate having an interior side and an exterior side opposite the interior side;
a cathode plate having an interior side and an exterior side opposite the interior side, the interior side of the cathode plate facing the interior side of the anode plate;
a bead region, a portion of the interior side of the anode plate at the bead region spaced from a portion of the interior side of the cathode plate at the bead region; and
an enforcement layer disposed between the interior side of the anode plate and the interior side of the cathode plate at the bead region, the enforcement layer configured to resist compression forces experienced at the exterior side of the anode plate and the exterior side of the cathode plate at the bead region.

17. The vehicle of claim 16, wherein each bipolar plate of the pair of bipolar plates further comprises:
a first gasket disposed at the exterior side of the anode plate at the bead region; and
a second gasket disposed at the exterior side of the cathode plate at the bead region, the first gasket and the second gasket engaging respective membrane electrode assemblies of the fuel cell stack.

18. The vehicle of claim 16, further comprising a chamber defined between the portion of the interior side of the anode plate at the bead region and the portion of the interior side of the cathode plate at the bead region, the enforcement layer extending within the chamber at the bead region.

19. The vehicle of claim 16, wherein the enforcement layer comprises a spline disposed between the portion of the interior side of the anode plate and the portion of the interior side of the cathode plate at the bead region and not disposed between other portions of the interior side of the anode plate and other portions of the interior side of the cathode plate remote from the bead region.

20. The vehicle of claim 16, wherein the enforcement layer comprises an intermediate plate disposed between the portion of the interior side of the anode plate and the portion of the interior side of the cathode plate at the bead region and disposed between other portions of the interior side of the anode plate and other portions of the interior side of the cathode plate remote from the bead region.
